(19) United States
(12) Patent Application Publication
(10) Pub. No.: US 2023/0135460 A1
(43) Pub. Date: May 4, 2023

(54) SPRING DEVICE FOR SECURING A THREADED FASTENER OF A BOLTED JOINT AND A SYSTEM FOR SECURING A BOLTED JOINT

(71) Applicant: SAAB AB, Linköping (SE)

(72) Inventor: Richard Sundberg, Bro (SE)

(21) Appl. No.: 17/974,636

(22) Filed: Oct. 27, 2022

(30) Foreign Application Priority Data
Nov. 3, 2021 (SE) 2100164-9

(51) Int. Cl. F16B 39/26

(52) U.S. Cl. CPC F16B 39/26

(57) ABSTRACT

A spring device for securing a threaded fastener of a bolted joint. The spring device includes at least one ring-shaped portion and a plurality of elongate spring elements. Each spring element is attached at least in a first end to the at least one ring-shaped portion. The at least one ring-shaped portion and a body formed by the plurality of spring elements have a common centre axis. Each spring element includes an inner peripheral surface directed towards the centre axis, and wherein a first portion of said inner peripheral surface is closer to the centre axis than are other portions of said inner peripheral surface and closer to the centre axis than an inner peripheral surface of the at least one ring-shaped portion. The disclosure further relates to a system for securing a bolted joint.

### CROSS-REFERENCE TO RELATED APPLICATIONS

The present application for patent claims priority to Swedish Application Ser. No. 2100164-9, entitled “A SPRING DEVICE FOR SECURING A THREADED FASTENER OF A BOLTED JOINT AND A SYSTEM FOR SECURING A BOLTED JOINT” filed on Nov. 3, 2021, assigned to the assignee hereof, and expressly incorporated herein by reference.

### TECHNICAL FIELD

The present disclosure generally relates to a threaded fastener of a bolted joint. More specifically, the disclosure relates to a spring device for securing a threaded fastener of a bolted joint and a system for securing a bolted joint.

### BACKGROUND

A problem with the solutions of the prior art is that the locking functionality is not conserved after the bolt has been removed. Put differently, anchor nuts or threaded inserts as well as anchor bolt, anchor wedge bolt and/or other types of expansion bolts has a limited number of use cycles with remained functionality.

The object of the invention is to provide a spring device and a system for securing a bolted joint, in which the spring device can be used during a plurality of cycles with remained functionality.

### SUMMARY

It is an object of the present disclosure to mitigate, alleviate or eliminate one or more of the above-identified deficiencies and disadvantages in the prior art and solve at least the above mentioned problem.

According to a first aspect there is provided a spring device for securing a threaded fastener of a bolted joint, wherein the spring device comprises at least one ring-shaped portion, and a plurality of elongate spring elements, wherein each spring element is attached at least in a first end to the at least one ring-shaped portion, wherein the at least one ring-shaped portion and a body formed by the plurality of spring elements have a common centre axis, wherein each spring element comprises an inner peripheral surface directed towards the centre axis, and wherein a first portion of the inner peripheral surface is closer to the centre axis than are other portions of the inner peripheral surface and closer to the centre axis than an inner peripheral surface of the at least one ring-shaped portion.

One advantage with the spring device is that it can be used in situations where conventional solutions are inadequate or impractical. One such situation are joints that needs to be loosened often. Today's solutions such as anchor nuts or threaded inserts that used to ensure that the threaded bolt will not unscrew itself has a limited number of loosening cycles before they need to be replaced. Preferably the material of the spring device is chosen such that the spring device is able to be used over at least ten, or at least fifty, or at least one hundred loosening cycles without performance degradation or need for replacement of the spring arrangement.

The spring device is arranged to be used in a fastener arrangement where the friction between the spring element and the fastener arrangement will ensure that the spring element stays in place in the fastener arrangement. In turn, the inner peripheral surface of each spring element extends inwards relative the at least one ring-shaped portion and when the spring device encloses a head of a threaded fastener, the the inner peripheral surface of each spring element exerts a friction force against the head of the threaded fastener to keep the head of the threaded fastener from rotating relative the spring device and the fastener arrangement. This ensures that the head of the threaded fastener, and therefor also the threaded fastener itself, is not able to move longitudinally relative the spring arrangement and the threaded fastener will stay in place.

According to some embodiments, the at least one ring-shaped portion comprises a ring-shaped first portion and a ring-shaped second portion which is in alignment with the ring-shaped first portion and wherein the ring-shaped first portion and the ring-shaped second portion have a common centre axis, and wherein each of the spring elements is connected in a first end to the ring-shaped first portion and in an opposite second end to the ring-shaped second portion. This has the effect of improved friction force against the head of the threaded fastener to keep the head of the threaded fastener from rotating relative the spring device and the fastener arrangement.

According to some embodiments, the ring-shaped first portion forms a first end portion of the spring device, and the ring-shaped second portion forms a second end portion of the spring device. The ring-shaped end portions add stability to the spring device. Preferably the ring-shaped first portion and the ring-shaped second portion have generally the same geometry. Thereby, it will not matter which end is introduced first into a predetermined hole. Both ends may form an equally stable engagement structure towards a radial support surface in a hole that receives the spring device.

According to some embodiments, said first portion of the inner peripheral surface of the spring element is a central portion of the spring element in the direction of the centre axis, and said other portions are a respective neighboring portion on each opposite side of the first portion, wherein said other portions extend from the first portion to the ring-shaped first portion and the ring-shaped second portion respectively.

This allows a head of the threaded fastener to press the central portion of the spring element, which engage the first and second end portion to press against the inner peripheral of a fasting arrangement, leading to increased friction keeping the head as well as the whole threaded fastener in portion.

One of the advantages of having spring elements with convex shapes directed towards the central axis is that the spring element can be naturally bent and thereby easily loosened without performance degradation or need for replacing the spring arrangement.

According to some embodiments, the at least one ring-shaped portion comprises a slit extending through said portion.

According to some embodiments, each of the ring-shaped first portion and the ring shaped second portion comprises a slit extending though said portion.

Having a slit enables an easy positioning of the spring element into a fastening arrangement since the outer diameter of the spring element can be decreased by simply squeezing the spring element. When the squeezed spring element is position in a fasting arrangement, the squeezing force is removed and the spring element will expand to normal size, i.e. the slit will open. In some example embodiments, the spring element may comprise more than one slit, wherein the slit are located on the first and/or the second end portion.

According to some embodiments, each spring element is able to deform elastically from an unloaded state in which said first portion of the inner peripheral surface is closer to the centre axis than are the other portions of the inner peripheral surface to a deformed state in which said first portion of the inner peripheral surface is in alignment with said the other portions of the inner peripheral surface. In other words, the spring device is able of deforming elastically, not plastically, to a state in which each spring element is generally rectilinear.

According to some embodiments, the spring device comprises a first material defining a core of each spring element and a layer of a second material applied on said first portion of the inner peripheral surface of the spring element, wherein the first material has a higher spring constant than the second material and the second material has a higher friction coefficient than the first material. The spring device is arranged to enclose a head of a threaded fastener, wherein the friction surface of each spring element exerts a friction force against the head of the threaded fastener. It is therefore advantageously to increase the friction of the surface facing the head of the threading fastener.

In another example embodiment, the outer surface of the first end portion and the second end portion may also be covered with the second material having a higher friction coefficient than the first material defining the core of the spring element. This will increase the friction between the first and second end portion.

According to some embodiments, an outer radius of the at least one ring-shaped portion defines the maximum outer radius of the spring device.

According to some embodiments, an outer radius of the ring-shaped first portion and an outer radius of the ring-shaped second portion are equal and define the maximum outer radius of the spring device. Thereby, the first and second end portions will form a stable support structure against a surrounding wall of a fastener arrangement, said surrounding wall defining a cylindrical hole.

According to a second aspect there is provided a system for securing a bolted joint, wherein the system comprises a spring device according to the first aspect, a threaded fastener, and a fastener arrangement comprising a hole arranged to receive the spring device and a head of the threaded fastener, wherein the head of the threaded fastener has a radius which, in an unloaded state of the spring device, is larger than the distance from the first portion of the inner peripheral surface of each spring element to the centre axis of the spring device and an outer radius of the at least one ring-shaped portion of the spring device corresponds to an inner radius of the hole and a centre axis of the hole is in alignment with the centre axis of the spring device when the spring device is received in the hole.

According to some embodiments, the fastener arrangement comprises a sleeve defining said hole. The fastener arrangement preferably also comprises a structural component that holds the sleeve in place, preventing it from rotating around said centre axis.

According to some embodiments, the at least one ring-shaped portion of the spring device comprises a slit extending through it, and the fastener arrangement comprises a projection at an inlet to said hole, said projection having a distance to the centre axis of the hole which is less than the outer radius of the at least one ring-shaped portion of the spring device when the latter is in a non-compressed state in which the slit is open, and which distance is larger than the outer radius of the at least one ring-shaped portion of the spring device when the latter is in a compressed state in which the slit is closed.

Effects and features of the second aspect are to a large extent analogous to those described above in connection with the first aspect. Embodiments mentioned in relation to the first aspect are largely compatible with the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a perspective view of the spring device according to an embodiment of the present disclosure.

FIG. 2a shows a perspective side view of the system according to an embodiment of the present disclosure.

FIG. 2b shows a perspective cross-sectional view of the system according to an embodiment of the present disclosure.

FIG. 2c shows a perspective exploded view of the system according to an embodiment of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

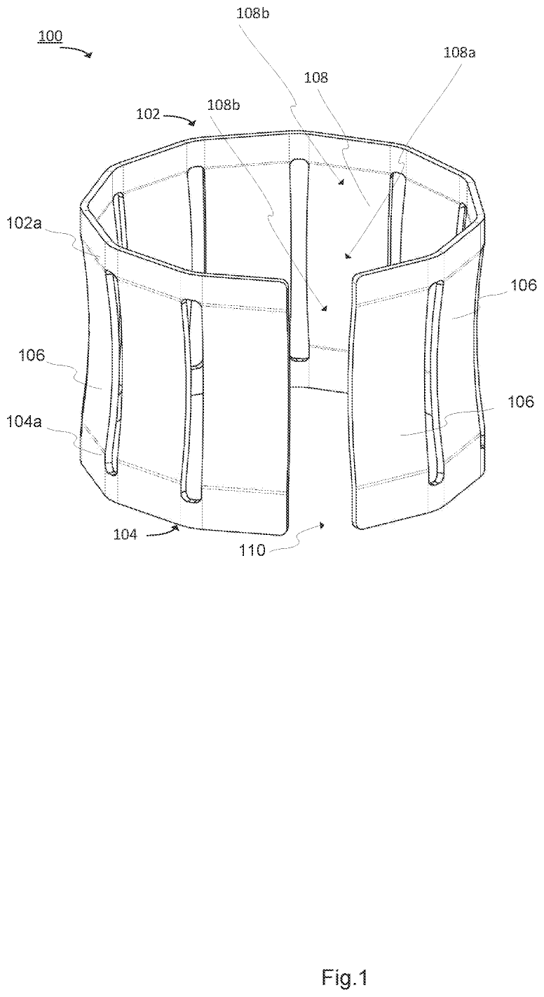

FIG. 1 shows a perspective view of the spring device 100 according to an embodiment of the present disclosure.

The first aspect of this disclosure shows a spring device 100 for securing a threaded fastener of a bolted joint (not shown). The spring device 100 comprises a ring-shaped first end portion 102, a ring-shaped second end portion 104, and a plurality of elongate spring elements 106. Each spring element 106 is attached in a first end 102a to the first end portion 102 and in an opposite second end 104a to the second end portion 104a. The first end portion 102 and the second end portion 104 are in alignment and have a common centre axis. Each spring element 106 comprises an inner peripheral surface 108 directed towards the centre axis, and wherein a first portion 108a of the inner peripheral surface 108 is closer to the centre axis than the other portions 108b of the inner peripheral surface 108. The first portion 108a of the inner peripheral surface 108 is also closer to the centre axis than the inner peripheral surface of the first end portion 102 as well as the inner peripheral surface of the second end portion 104.

The first portion 108a of the inner peripheral surface of the spring element 106 is a central portion of the spring element 106 in the direction of the centre axis, and wherein said other portions are a respective neighboring portions on each opposite side of the first portion 108a, wherein said other portions extend from the first portion 108a to the ring-shaped first portion 102 and the ring-shaped second portion 104 respectively.

Each of the ring-shaped first portion 102 and the ring shaped second portion 104 comprises a slit 110 extending though said portion. The slit enables the spring device 100 to be temporarily compressed to a smaller diameter.

The spring device 100 comprises a first material defining a core of each spring element 106 and a layer of a second material applied on said first portion 108a of the inner peripheral surface of the spring element 106, wherein the first material has a higher spring constant than the second material and the second material has a higher friction coefficient than the first material.

An outer radius of the ring-shaped first portion 102 and an outer radius of the ring-shaped second portion 104 are equal and define the maximum outer radius of the spring device 100.

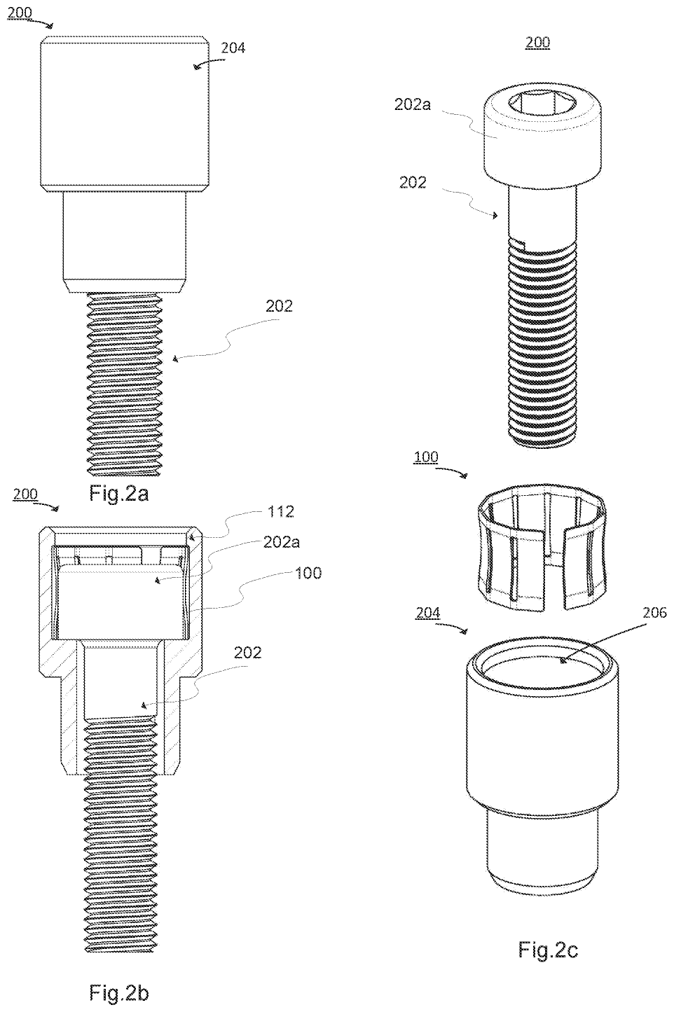

FIGS. 2a-2b show perspective views of the system 200 for securing a bolted joint according to an embodiment of the present disclosure.

FIG. 2a shows a perspective view of the system 200 for securing a bolted joint according to an embodiment of the present disclosure.

FIG. 2b shows a perspective cross-sectional of the same system 200 as shown in FIG. 2a.

The second aspect of this disclosure shows a system 200 for securing a bolted joint. The system 200 comprises a spring device 100 according to the first aspect, a threaded fastener 202, and a fastener arrangement 204 comprising a hole 206 (shown in FIG. 2c) arranged to receive the spring device 100 and a head 202a of the threaded fastener 202. The head 202a of the threaded fastener 202 has a radius which is larger than the distance from the first portion 108a of the inner peripheral surface 108 of each spring element 106 to the centre axis of the spring device 100. An outer radius of the at least one ring-shaped portion 102, 104 of the spring device 100 corresponds to an inner radius of the hole 206 and a centre axis of the hole 106 is in alignment with the centre axis of the spring device 100 when the spring device 100 is received in the hole.

The fastener arrangement 204 comprises a sleeve defining said hole 206. The at least one ring-shaped portion 102, 104 of the spring device 100 comprises a slit 110 extending through it, and the fastener arrangement comprises a projection 112 at an inlet to said hole, said projection 112 having a distance to the centre axis of the hole which is less than the outer radius of the at least one ring-shaped portion 102, 104 of the spring device 100 when the latter is in a non-compressed state in which the slit 110 is open. The distance is larger than the outer radius of the at least one ring-shaped portion 102, 104 of the spring device 100 when the latter is in a compressed state in which the slit 110 is closed.

1. A spring device for securing a threaded fastener of a bolted joint, the spring device comprising:
at least one ring-shaped portion and a plurality of elongate spring elements,
wherein each spring element is attached at least in a first end to the at least one ring-shaped portion,
wherein the at least one ring-shaped portion and a body formed by the plurality of spring elements have a common centre axis,
wherein each spring element comprises an inner peripheral surface directed towards the centre axis, and
wherein a first portion of said inner peripheral surface is closer to the centre axis than are other portions of said inner peripheral surface and closer to the centre axis than an inner peripheral surface of the at least one ring-shaped portion.

2. The spring device according to claim 1, wherein the at least one ring-shaped portion comprises a ring-shaped first portion and a ring-shaped second portion which is in alignment with the ring-shaped first portion and wherein the ring-shaped first portion and the ring-shaped second portion have a common centre axis, and wherein each of the spring elements is connected in a first end to the ring-shaped first portion and in an opposite second end to the ring-shaped second portion.

3. The spring device according to claim 2, wherein the ring-shaped first portion forms a first end portion of the spring device, and the ring-shaped second portion forms a second end portion of the spring device.

4. The spring device according to claim 2, wherein said first portion of the inner peripheral surface of the spring element is a central portion of the spring element in the direction of the centre axis, and wherein said other portions are respective neighboring portions on each opposite side of the first portion, wherein said other portions extend from the first portion to the ring-shaped first portion and the ring-shaped second portion respectively.

5. The spring device according to claim 1, wherein the at least one ring-shaped portion comprises a slit extending through said portion.

6. The spring device according to claim 2, wherein each of the ring-shaped first portion and the ring shaped second portion comprises a slit extending though said portion.

7. The spring device according to claim 1, wherein each spring element is able to deform elastically from an unloaded state in which said first portion of the inner peripheral surface is closer to the centre axis than are the other portions of the inner peripheral surface to a deformed state in which said first portion of the inner peripheral surface is in alignment with said the other portions of the inner peripheral surface.

8. The spring device according to claim 1, wherein the spring device comprises a first material defining a core of each spring element and a layer of a second material applied on said first portion of the inner peripheral surface of the spring element, wherein the first material has a higher spring constant than the second material and the second material has a higher friction coefficient than the first material.

9. The spring device according to claim 1, wherein an outer radius of the at least one ring-shaped portion defines the maximum outer radius of the spring device.

10. The spring device according to claim 2, wherein an outer radius of the ring-shaped first portion and an outer radius of the ring-shaped second portion are equal and define the maximum outer radius of the spring device.

11. A system for securing a bolted joint, wherein the system comprises:
a spring device comprising at least one ring-shaped portion and a plurality of elongate spring elements, wherein each spring element is attached at least in a first end to the at least one ring-shaped portion, wherein the at least one ring-shaped portion and a body formed by the plurality of spring elements have a common centre axis, wherein each spring element comprises an inner peripheral surface directed towards the centre axis, and wherein a first portion of said inner peripheral surface is closer to the centre axis than are other portions of said inner peripheral surface and closer to the centre axis than an inner peripheral surface of the at least one ring-shaped portion;
a threaded fastener; and
a fastener arrangement comprising a hole arranged to receive the spring device and a head of the threaded fastener,
wherein the head of the threaded fastener has a radius which, in an unloaded state of the spring device, is larger than the distance from the first portion of the inner peripheral surface of each spring element to the centre axis of the spring device and an outer radius of the at least one ring-shaped portion of the spring device corresponds to an inner radius of said hole and a centre axis of said hole is in alignment with the centre axis of the spring device when the spring device is received in the hole.

12. The system according to claim 11, wherein the fastener arrangement comprises a sleeve defining said hole.

13. The system according to claim 11, wherein the at least one ring-shaped portion of the spring device comprises a slit extending through it, and the fastener arrangement comprises a projection at an inlet to said hole, said projection having a distance to the centre axis of the hole which is less than the outer radius of the at least one ring-shaped portion of the spring device when the latter is in a non-compressed state in which the slit is open, and which distance is larger than the outer radius of the at least one ring-shaped portion of the spring device when the latter is in a compressed state in which the slit is closed.
